(19) United States
(12) Patent Application Publication
(10) Pub. No.: US 2025/0212715 A1
(43) Pub. Date: Jul. 3, 2025

(54) TRANSPORT HYDRAULIC PRESSURE USED TO BLOCK RETRACTION OF HEADER TILT CYLINDER

(71) Applicant: CNH Industrial America LLC, New Holland, PA (US)

(72) Inventors: Jeffrey Fay, II, Oxford, PA (US); Glenn Bird, Ephrata, PA (US)

(21) Appl. No.: 18/397,097

(22) Filed: Dec. 27, 2023

(51) Int. Cl. A01B 73/00; A01D 69/03; F15B 13/04

(52) U.S. Cl. CPC A01B 73/005; A01D 69/03; F15B 13/0401

(57) ABSTRACT

An agricultural machine having: a chassis; field wheels; a header having harvesting elements; a tilt actuator connected between the header and the chassis and configured to receive a pressurized hydraulic fluid to operate the tilt actuator to raise the header from a lowered position; and a hydraulic circuit configured to reconfigure the agricultural machine between a field position and a transport position. The hydraulic circuit has a pilot valve located in a tilt actuator input path and movable to selectively open and close the tilt actuator input path, and a hydraulic actuator configured to receive a pressurized hydraulic fluid to operate the actuator during reconfiguration of the machine from a field position to a transport position. The pilot valve is configured to close when pressurized hydraulic fluid is received from the actuator input, and open position when the hydraulic fluid is not received at the pilot valve.

### FIELD OF THE INVENTION

The present invention pertains to an agricultural mowing device and, more specifically, to a transport system for the agricultural mowing device.

### BACKGROUND OF THE INVENTION

A farmer may use an agricultural mowing device, such as a mower or mower conditioner, to cut crop material like hay or grass and deposit the cut crop material onto the field in windows or swaths. Typically, the mowing device is towed behind an agricultural vehicle, such as a tractor. For cutting large fields, many mowing assemblies include a driving vehicle that pushes a mowing device conditioner in front of the vehicle while simultaneously pulling another mowing device conditioner behind the vehicle.

A mowing device generally includes a towing tongue connectable to the tractor, a chassis (e.g., a trail frame), a cutting device, and a transport system. A mowing device conditioner additionally includes conditioning rollers for conditioning the cut crop material. The mowing device can be variously configured as a disc, sickle, or drum mowing device wherein the cutting device includes a series of rotatable discs, a sickle bar, or a rotating drum, respectively. In a disc-type mowing device, such as a discbine®, the disc cutter bar may generally include multiple juxtaposed cutterheads for cutting the standing crop. Each cutterhead may consist of a rotating disc with diametrically opposed cutting blades or knives affixed to the body of the disc.

The transport system of a pull-behind mowing device is used to reduce the overall profile of the mowing device for transportation thereof. Generally, due to practical or regulatory limits, the width of the mowing device in its operating orientation prevents the towed transportation of the mowing device on farm lanes, roadways, or through gates. To reduce the width of the mowing device, the transport system may include a separate transport trailer or an integrated transport subframe with transport wheels that selectively support the mowing device.

The separate transport trailer may reorient the mowing device and carry the mowing device with its width extending along the longitudinal length of the transport trailer. In this regard, the mowing device is arranged parallel to the forward direction of travel of the towing vehicle. Such transport trailers may be useful; however, these transport trailers may add significant cost to the overall mowing operation. For instance, such transport trailers must be separately purchased, maintained, and transported between the various fields and farm headquarters, which increases the operating cost of a mowing operation.

Integrated transport systems typically include a pivotable subframe with wheels for selectively supporting the mowing device and multiple actuators for pivoting the mowing device to be parallel with the forward direction of travel of the towing vehicle. The time required for deployment of these integrated systems may introduce unwanted delays.

Examples of integrated transport systems are shown in U.S. Pat. Nos. 10,631,452; 4,800,962; European Patent Pub. EP 1095551 B1; and European Patent Pub. EP 0509307, all of which are incorporated by reference herein.

What is needed in the art is a cost-effective and efficient integrated lateral transport system for a mowing device.

### BRIEF SUMMARY OF THE INVENTION

In a first exemplary aspect, there is provided an agricultural machine comprising: a chassis; field wheels configured to selectively support the chassis to move on a ground surface; a header operatively coupled to the chassis and movable between a lowered position relative to the chassis and a raised position relative to the chassis, the header comprising harvesting elements; a tilt actuator operatively connected between the header and the chassis and comprising a tilt actuator input path configured to receive a respective pressurized hydraulic fluid to operate the tilt actuator to move the header from the lowered position to the raised position; and a hydraulic circuit configured to reconfigure the agricultural machine between a field position and a transport position. The hydraulic circuit comprises: a pilot valve located in the tilt actuator input path and movable between an open position in which the pilot valve does not block the tilt actuator input path and a closed position in which the pilot valve blocks the tilt actuator input path, and a first hydraulic actuator having a first actuator input configured to receive a respective pressurized hydraulic fluid to operate the first hydraulic actuator during reconfiguration of the agricultural machine from the field position to the transport position. The pilot valve is operatively connected to the first actuator input and configured to move to the closed position when a respective pressurized hydraulic fluid is received at the pilot valve from the first actuator input and move to the open position when the respective hydraulic fluid is not received at the pilot valve.

In another exemplary aspect, there is provided an agricultural machine comprising: a chassis; field wheels operatively coupled to the chassis and movable between a respective extended position relative to the chassis to support the chassis to move on a ground surface and a respective retracted position relative to the chassis; a lift actuator operatively connected between the field wheels and the chassis and configured to move the field wheels from the retracted position to the extended position; a header operatively coupled to the chassis and movable between a respective lowered position relative to the chassis and a respective raised position relative to the chassis, the header comprising harvesting elements; a tilt actuator operatively connected between the header and the chassis and configured to move the header at least from the lowered position to the raised position; and a hydraulic system configured to reconfigure the agricultural machine between a field position and a transport position. The hydraulic system comprises: a first hydraulic circuit configured to selectively apply a first hydraulic pressure to the lift actuator to move the field wheels to the extended position and to the tilt actuator to move the header to the raised position, a valve configured to move to a closed position to hydraulically disconnect the tilt actuator from the lift actuator and maintain the first hydraulic pressure in the tilt actuator after terminating application of the first hydraulic pressure to the lift actuator, and a second hydraulic circuit configured to selectively apply a second hydraulic pressure to move the valve to the closed position.

In another exemplary aspect, there is provided a method for operating an agricultural machine comprising a chassis, field wheels configured to selectively support the chassis on a surface, a header, and a tilt actuator operatively connected between the header and the chassis. The method comprises: extending the field wheels relative to the chassis to raise the chassis relative to the surface; applying a first hydraulic pressure to the header via a tilt actuator input path to move the header to a raised position relative to the chassis; applying a second hydraulic pressure to one or more actuators to reposition the agricultural machine from a field position to a transport position; and applying the second hydraulic pressure to a valve in the tilt actuator input path to close the valve and lock the header in the raised position.

This summary is illustrative only and is not intended to be in any way limiting. Other aspects, inventive features, and advantages of the devices or processes described herein will become apparent in the detailed description set forth herein, taken in conjunction with the accompanying figures.

### BRIEF DESCRIPTION OF THE SEVERAL VIEWS OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIGS. 1-5 are different views of an exemplary mowing device shown in various operating positions.

FIGS. 6A and 6B are side views of a portion of a mowing device shown with a header in lowered position in FIG. 6A and a raised position in FIG. 6B.

FIGS. 7-12 show an exemplary hydraulic circuit for a mowing device in various operating states.

FIG. 13 shows another embodiment of a portion of a hydraulic circuit, with a pilot input of a pilot valve operatively connected to a flail curtain actuator.

FIG. 14 shows another embodiment of a portion of a hydraulic circuit, with a pilot input of a pilot valve operatively connected to a windrow shield actuator.

FIG. 15 shows another embodiment of a portion of a hydraulic circuit, with a pilot input of a pilot valve operatively connected to a transport swing actuator.

FIG. 16 is a block diagram of an exemplary method for operating a mowing device.

### DETAILED DESCRIPTION OF THE INVENTION

The terms “forward”, “rearward”, “left” and “right”, when used in connection with the agricultural mowing device and/or components thereof are usually determined with reference to the direction of forward operative travel of the towing vehicle, but they should not be construed as limiting. The terms “longitudinal” and “transverse” are determined with reference to the fore-and-aft direction.

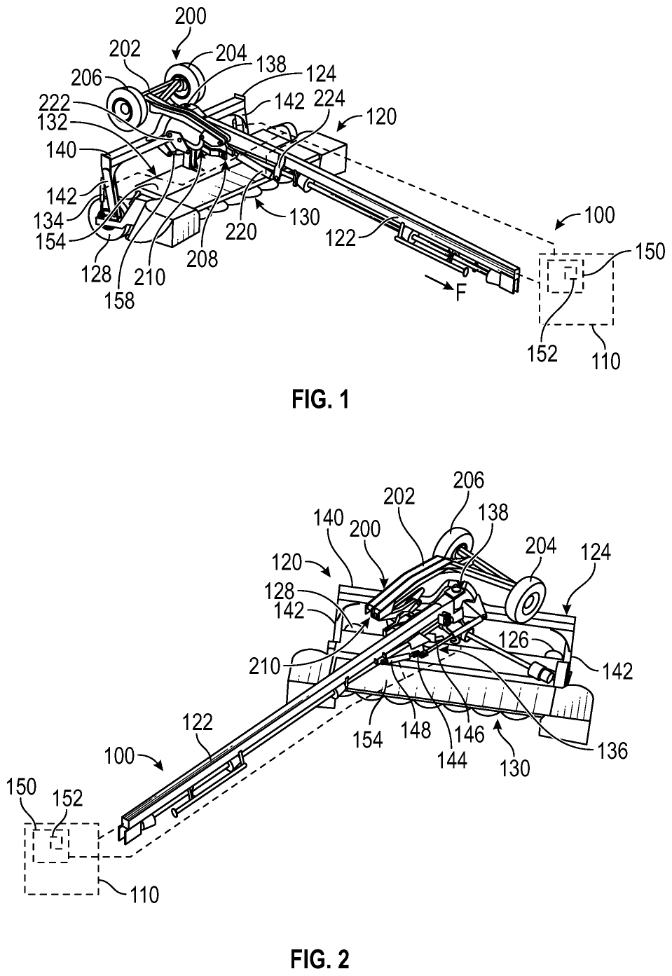

Referring now to the drawings, and more particularly to FIGS. 1-5, there is shown an example of a known agricultural mowing assembly 100 that includes an agricultural vehicle 110 and an agricultural mowing device 120, which is towed by the agricultural vehicle 110 in a forward direction of travel F. The agricultural vehicle 110 generally includes a chassis, a prime mover, wheels and/or tracks, and a cab for housing the operator. The vehicle 110 can be in the form of any desired agricultural vehicle, such as a tractor or self-propelled windrower.

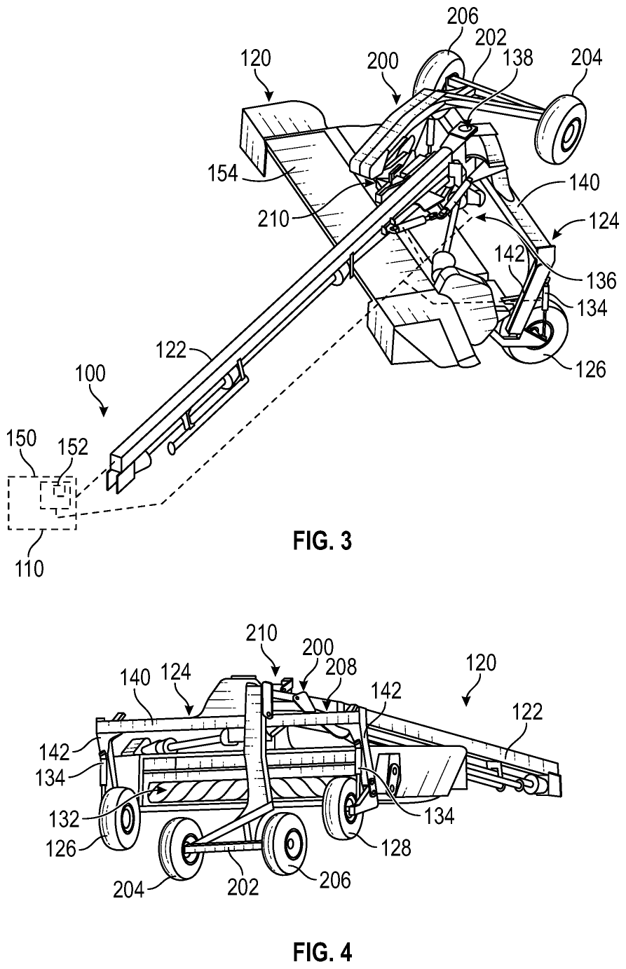

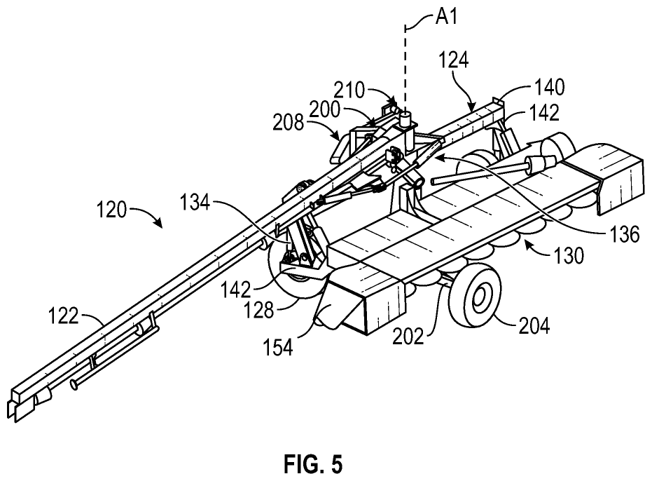

The mowing device 120 may be in the form of a center pivot mowing device or mowing device conditioner 120. As shown, the mowing device 120 is in the form of a center pivot mowing device conditioner 120. However, the mowing device 120 may be in the form of any desired mowing device. The mowing device 120 is configurable in a field position for cutting a crop material in the field (FIGS. 1-3) and a transport position for transporting the agricultural mowing device 120 (FIG. 5). The mowing device 120 may also be positioned between various field positions, such as an intermediate field position (FIG. 1), a full field left position (FIG. 2), and a full field right position (FIG. 3).

The mowing device 120 may generally include a towing tongue 122 connected to the agricultural vehicle 110, a trail frame 124 rotatably connected to the towing tongue 122 about an axis of rotation A1, trail frame wheels 126, 128, a cutter bar 130, a pair of conditioning rollers 132, a pair of lift actuators 134 operably connected in between the trail frame 124 and the trail frame wheels 126, 128, a trail frame actuating mechanism 136 for rotating the trail frame 124 and the cutter bar 130 therewith, and a lateral transport system 200 connected to the towing tongue 122 for selectively supporting the mowing device 120 in the transport position. The mowing device 120 may also include a controller 150, with a memory 152, for automatically controlling the trail frame actuating mechanism 136 and the transport system 200 and/or effectuating user inputs to perform one or more control operations.

The towing tongue 122 removably connects to the agricultural vehicle 110. The towing tongue 122 has a first, proximal end and a second, distal end. The first end of the towing tongue 122 is connected to the agricultural vehicle 110. The second end of the towing tongue 122 rotatably mounts the trail frame 124 about the axis of rotation. The second end of the towing tongue 122 may rotatably mount the trail frame 124 via any desired mounting bracket 138 (e.g., a pivot pin or bearing arrangement). The towing tongue 122 may comprise any desired material, such as metal.

The trail frame 124 is rotatably connected to the towing tongue 122 via the mounting bracket 138 and the trail frame 124 accordingly rotates about the vertical axis of rotation A1. The trail frame 124 has a horizontal main beam 140 and a pair of vertical side beams 142 which downwardly extend from the main beam 140. The main beam 140 is rotatably connected to the towing tongue 122 about the axis of rotation A1. The main beam 140 is located underneath the transport system 200. The side beams 142 respectively rotatably mount the trail frame wheels 126, 128. The trail frame 124 supports the weight of the mowing device 120 in the field position but the trail frame 124 does not support the weight of the mowing device 120 in the transport position. Hence, the trail frame wheels 126, 128 support the trail frame 124 in the field position but do not support the trail frame 124, or any other component of the mowing device 120, in the transport position (FIG. 5). The trail frame 124 may comprise any desired shape and material.

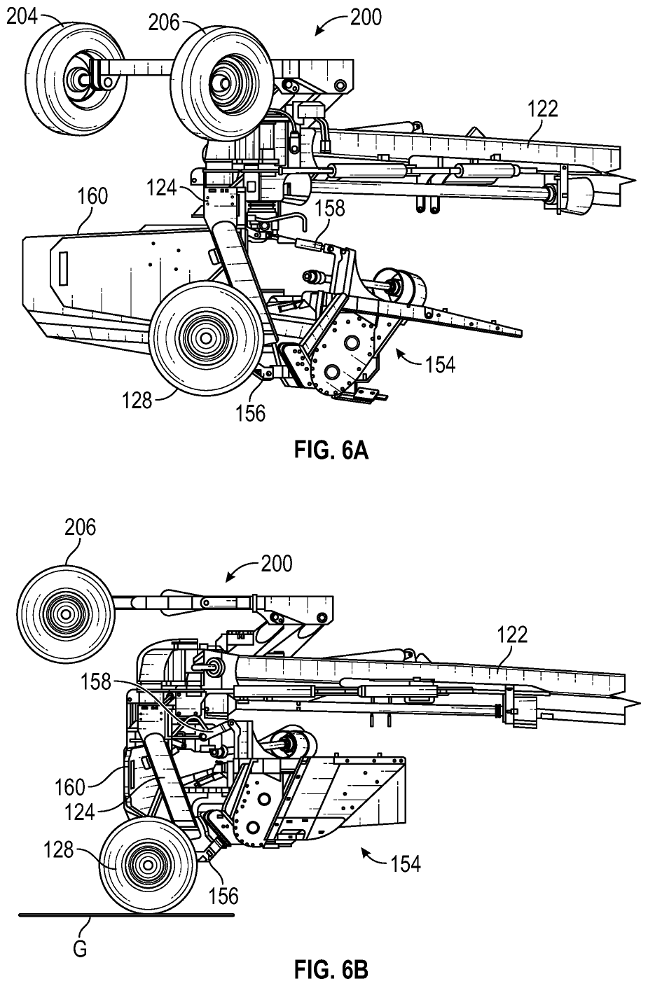

The cutter bar 130 is mounted to a header 154, and the header is movably connected to the trail frame 124 via a linkage or pivot. For example, as shown in FIGS. 6A and 6B, the header 154 may be attached to the trail frame 124 by a link 156 that is pivotally connected to the trail frame 124 to move between a lowered position in the field position (FIG. 6A) and a raised position in the transport position (FIG. 6B) (FIG. 6B also shows the field wheels 126, 128 being extended downward to elevate the trail frame 124). In this case, the link 156 provides a simple pivot rotation motion to tilt the header 154, but the link 156 may comprise a more complex linkage, such as a four-bar linkage, that causes the header 154 to move in other ways relative to the trail frame 124 (e.g., while remaining parallel to the ground rather than tilting more at the leading edge). For purposes herein, the term “tilt” refers to any kind of lifting motion of the header 154 relative to the trail frame 124, whether about a single axis, a virtual axis, or in a purely linear manner to remain parallel to the ground as the header moves.

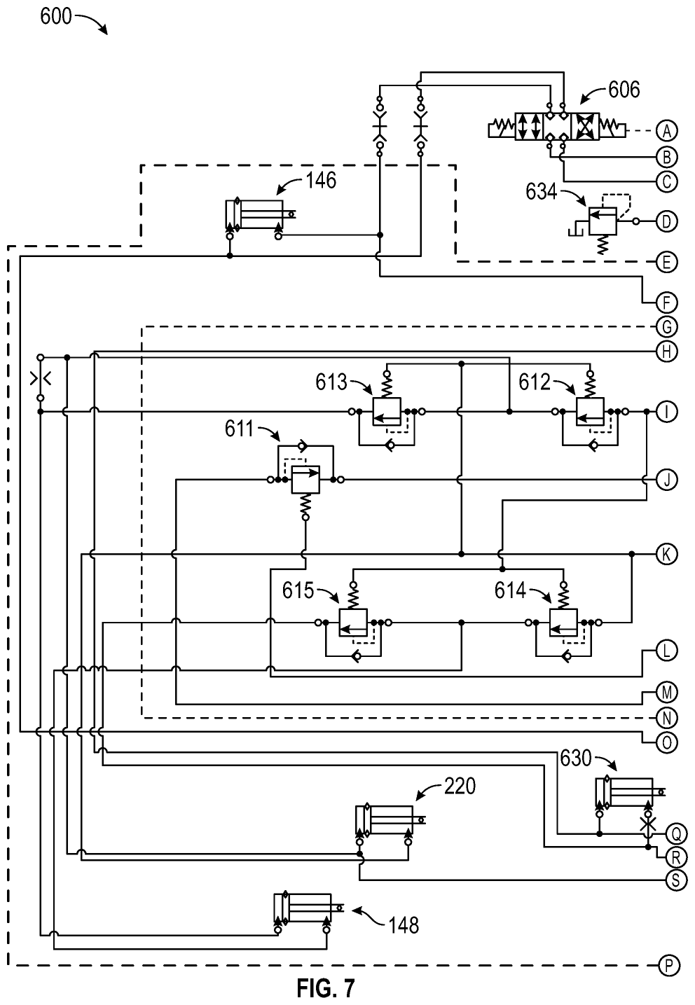

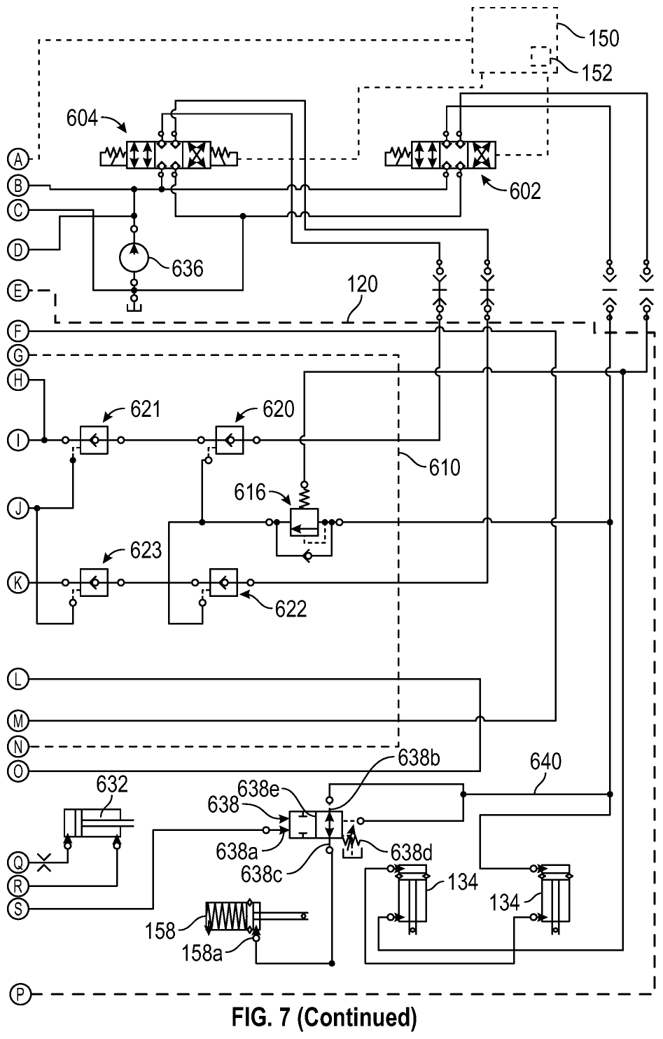

A tilt actuator 158 is provided to tilt the header 154 relative to the trail frame 124. The tilt actuator 158 may be a double-acting hydraulic device that drives the header 154 in both the downward and upward directions, or it may be a single-acting hydraulic device that only operates to lift or lower the header 154 relative to the trail frame 124, with reverse operation being provided by a spring, gravity, or the like. In the shown example, particularly as shown in FIG. 7, the tilt actuator 158 comprises a single-acting hydraulic actuator having a pressure inlet 158a on the rod side, and a vented cylinder side. The cylinder side also may include a mechanical or pneumatic biasing mechanism to push the header 154 down when hydraulic pressure is not applied to the rod side (i.e., a single-acting hydraulic actuator with a return spring), but this is not strictly necessary. The biasing mechanism may comprise, for example, a coil spring or other mechanical spring, a pressurized pneumatic accumulator, or the like. The biasing mechanism also may be separate from the tilt actuator 158 (e.g., a spring directly between the trail frame 124 and the header 154).

The cutter bar 130 cuts the crop material in the field position. The cutter bar 130 may be in the form of any desired cutter bar 130, such as a sickle bar or rotating disc cutter bar. The cutter bar 130 has a front end or edge and a back end or edge that is located behind the front end in the direction of crop material flow, i.e., opposite to the forward direction travel F. The front end of the cutter bar 130 defines a front longitudinal axis. It should be appreciated that the front edge of the cutter bar 130 may be defined by the front edge of rock guards or other leading structures or devices.

The conditioning rollers 132 are located downstream of the cutter bar 130. The conditioning rollers 132 condition the crop material as it exits the mowing device 120. The conditioning rollers 132 may be in the form of any desired rollers. As can be appreciated, the mowing device 120 may or may not include conditioning rollers 132.

The mowing device 120 also may include features such as windrow shields 160, a flail curtain, and so on, which may be movably mounted to the trail frame 124 or header 154 via actuators, as discussed more below.

The lift actuators 134 are respectively connected in between the trail frame 124 and the trail frame wheels 126, 128. More particularly, each lift actuator 134 is connected in between the trail frame 124 and an extension bracket (unnumbered) of a respective trail frame wheel 126, 128. The lift actuators 134 pivot the trail frame wheels 126, 128 up or down to thereby raise or lower the trail frame 124, i.e., the rear of the mowing device 120. Thereby, the lift actuators 134 may create additional clearance or space for allowing the transport system 200 to move into a position for supporting the mowing device 120. The lift actuators 134 may be in the form of any desired hydraulic and/or electric cylinders. For example, the lift actuators 134 may be in the form of hydraulic lift cylinders 134 which are hydraulically connected to the hydraulic system of agricultural vehicle 110 via one or more fluid lines.

The trail frame actuating mechanism 136 is operably connected in between the towing tongue 122 and the trail frame 124. The trail frame actuating mechanism 136 rotates the trail frame 124 in between its field positions for field operation and into its lateral position for transport. As used herein, the field right and left positions of the trail frame 124 may refer to any desired field-operating orientation of the trail frame 124 in which the trail frame 124 is not perpendicular to the towing tongue 122.

The trail frame actuating mechanism 136 includes a rotational link 144, a first trail frame actuator 146 (a field swing actuator), and a second trail frame actuator 148 (a transport swing actuator; FIG. 2). The rotational link 144 is rotatably connected to the towing tongue 122 and extends outwardly from the towing tongue 122. The rotational link 144 may be in the form of a flat plate. The rotational link 144 operably connects the first and second trail frame actuators 146, 148 to the towing tongue 122 at a location which is distally located away from the towing tongue 122 so that the first and second trail frame actuators 146, 148 may act in conjunction to swing the trail frame 124 between its field right and left positions and also rotate the trail frame 124 into and out of its lateral position in the transport position. The rotational link 144 is capable of rotating forwardly or rearwardly relative to the towing tongue 122 upon retraction or extension of the first and/or second trail frame actuators 146, 148.

The first trail frame actuator 146 is connected to the trail frame 124, via a corresponding bracket (unnumbered), and the rotational link 144. The second trail frame actuator 148 is connected to the towing tongue 122 and the rotational link 144. The first and/or second trail frame actuator 146, 148 may be used to rotate the trail frame 124 throughout any desired position of the trail frame 124. By way of example only, the first trail frame actuator 146 may be in the form of a field swing actuator 146 for rotating the trail frame 124 in between its field intermediate, right, and left positions. The second trail frame actuator 148 may be in the form of a transport swing actuator 148 for rotating the trail frame 124 in between its lateral position for transport and its extended, e.g., substantially perpendicular, field position for field operation. The first and second trail frame actuators 146, 148 may be in the form of any desired hydraulic and/or electric cylinders. For example, the first and second trail frame actuators 146, 148 may be in the form of hydraulic cylinders 146, 148 which are hydraulically connected to the hydraulic system of agricultural vehicle 110 via one or more fluid lines. As can be appreciated, the first and second trail frame actuators 146, 148 may or may not be identical actuators.

It will be appreciated that, where a single actuator is described, multiple actuators may be present to operate in parallel or series to perform the actuation function. For example, the single tilt actuator 158 may be replaced by multiple tilt actuators acting in parallel. Similarly, where multiple actuators are described, a single actuator may be present to perform the actuation function. For example, the two lift actuators 134 may be replaced by a single lift actuator operatively connected to both field wheels 126, 128. Thus, as used herein, the term “actuator” will be understood to mean one or more actuators.

The transport system 200 supports the mowing device 120, e.g., the trail frame 124, the cutter bar 130, the header 154, and/or the towing tongue 122, in the transport position (FIG. 5) but does not support the mowing device 120 in the field position (FIGS. 1-3). The transport system 200 includes a transport frame 202 rotatably connected to the towing tongue 122, transport wheels 204, 206 rotatably connected to the transport frame 202, and a transport actuating mechanism 208 for movably, i.e., rotatably, connecting the transport frame 202 to the towing tongue 122. Since the transport system 200 is connected to the side of the towing tongue 122, the transport system 200 does not move in conjunction with the trail frame 124. Also, the side or lateral location of the transport system 200 allows the weight of the mowing device 120 to be more evenly distributed between the transport wheels 204, 206.

The transport frame 202 is rotatable in between a retracted stowed position in the field position wherein the transport frame 202 is located above the trail frame 124 (FIGS. 1-3) and an extended support position in the transport position wherein the transport wheels 204, 206 support the trail frame 124 (FIG. 5) on a transport surface (e.g., the ground or a roadway). The transport frame 202 is rotatably connected to the towing tongue 122, via the transport actuating mechanism 208, at a location forward of the axis of rotation A1 of the trail frame 124 in the direction of forward travel F. Hence, the transport frame 202 is at least partially located in front of the axis of rotation A1 of the trail frame 124 in the direction of forward travel F in the field position, and the transport frame 202 is located rearwardly of the axis of rotation A1 of the trail frame 124 in the direction of forward travel F in the transport position. The transport frame 202 rotates about a substantially horizontal axis of rotation, plus or minus 30 degrees. Also, the connection point of the transport frame 202 is located vertically above the main beam 140 of the trail frame 124. Thus, the main beam 140 is located underneath the transport frame 202 in the field position such that the main beam 140 passes underneath the transport wheels 204, 206 when the transport frame 202 is in the retracted stowed position in the field position.

The transport frame 202 may include one or more beams which support a respective axle for mounting the transport wheels 204, 206. Hence, the transport wheels 204, 206 are jointly mounted on a axle rotation axis. The transport frame 202 may comprise any desired shape and material.

The first and second transport wheels 204, 206 support the weight of the mowing device 120, e.g., the weight of the trail frame 124, the cutter bar 130, and/or the towing tongue 122, upon being fully deployed in the transport position of the mowing device 120. The first transport wheel 204 may be considered a front or left transport wheel 204, and the second transport wheel 206 may be considered a back or right transport wheel 206. The transport wheels 204, 206 may be identical and thus have the same material, size, and weight capacity. The transport wheels 204, 206 may comprise any desired wheels. The first transport wheel 204 is radially located closer to the axis of rotation A1 of the trail frame 124 than the front end of the cutter bar 130 in the transport position. Hence, both transport wheels 204, 206 are located behind the front longitudinal axis of the front end of the cutter bar 130, which in turn more evenly distributes the weight of the mowing device 120 between the front and rear transport wheels 204, 206.

The transport actuating mechanism 208 includes a linkage assembly 210, with multiple links (unnumbered), and a transport actuator 220 operably connected in between the towing tongue 122 and the transport frame 202, via the linkage assembly 210. The transport actuating mechanism 208 may also include one or more brackets 222, 224 for mounting the linkage assembly 210 and the transport actuator 220 to the side of the towing tongue 122. For instance, one bracket 222 may be in the form of an elongated bracket that extends outwardly and perpendicularly from the side of the towing tongue 122, and another bracket 224 may be in the form of a shorter actuator bracket 224 that is connected to the side of the towing tongue 122 in front of the location point of the elongated bracket 222. The linkage assembly 210 is rotatably connected in between the transport frame 202 and the towing tongue 122.

The linkage assembly 210 may include a first link connected in between the elongated bracket 222 and the transport frame 202, a second, upper link connected in between the elongated bracket 222 and the transport frame 202, a third link connected to the second link, and a fourth link connected to the elongated bracket 222, the third link, and the transport actuator 220. It should be appreciated that the linkage assembly 210 may include any desired number of links, such as two, three, four, five, or more links. The transport actuator 220 may be connected in between the linkage assembly 210, i.e., fourth link, and the towing tongue 122 via the actuator bracket 224. The transport actuator 220 may be in the form of any desired hydraulic and/or electrical cylinder. For instance, the transport actuator 220 may be in the form of a hydraulic cylinder 220 that is hydraulically connected to the hydraulic system of agricultural vehicle 110 via one or more fluid lines. The transport actuator 220 may be the only actuator for moving the transport frame 202.

The controller 150 is operably connected to operate one or move valves that control hydraulic pressure to the lift, trail frame, and transport actuators 134, 146, 148, 220, and other actuators. The controller 150 may also be operably connected to a user interface within the cab of the agricultural vehicle 110. The controller 150 may automatically position the mowing device 120 in its transport position or field position upon the user inputting a corresponding command into the user interface. The controller 150 may be a standalone controller or integrated into the existing hardware and/or software of the agricultural vehicle 110 and/or mowing device 120.

There is shown, in FIGS. 7-12, an exemplary hydraulic system 600 for the transport system 200. The hydraulic system 600 may generally include the lift actuators 134, the field swing actuator 146, the transport swing actuator 148, the tilt actuator 158, the transport actuator 220, and directional control valves 602, 604, 606 fluidly connected to the lift actuators 134, field and transport swing actuators 146, 148, and the transport actuator 220. The directional control valves 602, 604, 606 may include a lift valve 602 fluidly connected to the lift actuators 134 and tilt actuator 158, a transport valve 604 fluidly connected to the transport swing actuator 148 and the transport actuator 220, and a swing valve 606 fluidly connected to the field swing actuator 146.

The lift, transport, and swing valves 602, 604, 606 may be operably connected to the controller 150, e.g., via solenoids or electric motors. Thereby, the controller 150 may selectively activate the lift, transport, and swing valves 602, 604, 606 to position the mowing device 120 in between its field and transport positions. Accordingly, the hydraulic system 600 may include a lift function, a swing function, a transport deployment function, and a transport stowage function for controlling the operation of the lift actuators 134, the tilt actuator 158, the field swing actuator 146, the transport swing actuator 148, and the transport actuator 220.

The hydraulic system 600 may also include a hydraulic manifold 610 with multiple hydraulic fluid lines, sequence valves 611, 612, 613, 614, 615, 616, and pilot operated check valves 620, 621, 622, 623. The hydraulic manifold 610 is fluidly connected in between the actuators 134, 146, 148, 220 and their corresponding valves 602, 604, 606. The hydraulic system 600 also may or may not include a windrow shield actuator 630, for folding the windrow shields 160 in the transport position, and a flail curtain actuator 632 for storing the flail curtain in the transport position. Furthermore, the hydraulic system 600 may include a relief valve 634, hydraulic pump 636, and multiple shuttle valves and couplings (unnumbered).

The hydraulic system 600 may be incorporated as part of the agricultural vehicle 110 and/or the mowing device 120. For instance, the directional valves 602, 604, 606, hydraulic pump 636, and relief valve 634 may be positioned on the agricultural vehicle 110 and the hydraulic manifold 610 and actuators 134, 146, 148, 220 may be located on the mowing device 120. It should be appreciated that the hydraulic manifold 610 may be automatically and/or manually controlled. For instance, the hydraulic system 600 may include one or more hand-controlled inputs, e.g., levers, switches, etc., which the operator can manually operate to activate any desired component of the hydraulic system 600, such as the directional valves 602, 604, 606. In other instances, the hydraulic system 600 may include one or more electronic inputs, e.g., switches, logic gates, etc., which a computer system can actuate to activate one or more components of the hydraulic system 600, such as the directional valves 602, 604, 606.

The hydraulic system 600 may have a built-in lockout feature wherein the transport hydraulics, e.g., the transport swing actuator 148 and the transport actuator 220, and fluid lines thereof, are prevented from operating unless the field swing cylinder 146 is fully retracted in the full field right position of the mowing device 120 and the lift actuators 134 are fully extended in the fully elevated position of the mowing device 120. For example, the check valves 620, 621, 622, 623 may be configured to render the transport swing actuator 148 and the transport actuator 220 non-functional at any time when the lift actuators 134 are not fully extended and the field swing actuator 146 is not fully retracted. Thus, this lockout feature prevents the use of the transport system 200 during field operation, such as when mowing, or during roadway transport.

Furthermore, the hydraulic system 600 also ensures that the trail frame 124 cannot rotate in the wrong direction during the final stage of deploying the transport system 200, which may cause damage to the trail frame 124 and/or transport system 200. For instance, the lockout feature ensures that the trail frame 124 is located in its full field right position, as opposed to the field left or intermediate position, such that when the transport frame 202 is rotated downwardly it does not contact the trail frame 124, and once the transport frame 202 is fully deployed, the trail frame 124 is prevented from rotating in the wrong direction, which would cause the trail frame 124 to contact the transport frame 202.

As noted above, the mowing device includes a header 154 that can be raised by operating the tilt actuator 158. In some cases, it can be desirable to maintain the header 154 in the raised position during transport, such as to minimize the overall width of the mowing device 120, allow the header 154 to fully clear the transport wheel 204 over which the header 154 is located in the transport position, and so on. In some equipment, such as that shown in U.S. Pat. No. 10,631,452, the header is held in the raised transport position by continuously applying hydraulic pressure from the hydraulic pump to the tilt actuator. While effective, an interruption in pressurized hydraulic fluid (e.g., via a pump failure or line break) can cause the header to drop during transport, potentially leading to damage or operator inconvenience.

It has been determined that a mowing device hydraulic system 600 can be improved, potentially at relatively little cost and complexity, by including a valve such as a valve 638 that is configured to hold the tilt actuator 158 with the header 154 in the raised position. The valve 638 itself may comprise any suitable hydraulically-actuated valve, such as a so-called pilot valve, but the term “pilot” is not intended to be limiting where it is used herein. In the shown example, the valve 638 includes a pilot input 638a, a flow inlet 638b, a flow outlet 638c, and a return spring 638d. A shuttle body 638e is provided to selectively open and close the path from the flow inlet 638b to the flow outlet 638c. More specifically, the return spring 638d biases the shuttle body 638e towards the open position, and hydraulic pressure applied at the pilot input 638a works against the return spring 638d to move the shuttle body 638e to the closed position. It will be understood that the return spring 638d may be replaced by a pressurized fluid supply or the like, and further options and details for valves 638 will be understood to those of ordinary skill in the art and need not be described in detail herein.

The valve 638 is located in the tilt actuator input path 640, which leads from the hydraulic pump 636 (e.g., via one or more valves) to the tilt actuator hydraulic input 158a. When the pilot valve 638 is in the open position, hydraulic fluid can flow through the tilt actuator input path 640, and when the pilot valve 638 is in the closed position, hydraulic fluid cannot flow through the tilt actuator input path 640. Furthermore, when the pilot valve 638 is in the closed position, the hydraulic fluid within the tilt actuator 158 cannot return or vent, and therefore the tilt actuator 158 is locked in place to hold the header 154 in the raised position. In the shown arrangement, the tilt actuator 158 comprises a telescoping rod that is retracted into the corresponding cylinder to place the header 154 in the raised position, but the opposite arrangement (i.e., an extension rod) may be used.

The pilot input 638a is hydraulically connected to a portion of the hydraulic circuit 600 that is pressurized during the process of reconfiguring the mowing device 120 from the field position to the transport position. For example, the pilot input 638a may be connected to one or more one or more of the transport swing actuator 148, the transport actuator 220, the windrow shield actuator 630 (if provided), and the flail curtain actuator 632 (if provided). Thus, the hydraulic pressure used to effectuate the transition to the transport position is also used to move the pilot valve 638 to the closed position. The location of the hydraulic connection may be selected based on various factors, such proximity of the operating parts to minimize installation complexity and/or to coordinate application of hydraulic pressure. Also, sequence valves, throttles, and other mechanisms may be provided in the connection path.

An exemplary operation of a hydraulic circuit 600 is illustrated in sequence in FIGS. 7-12.

FIG. 7 shows the hydraulic circuit 600 in a starting state, as may be present while operating in the field or during an idle stop.

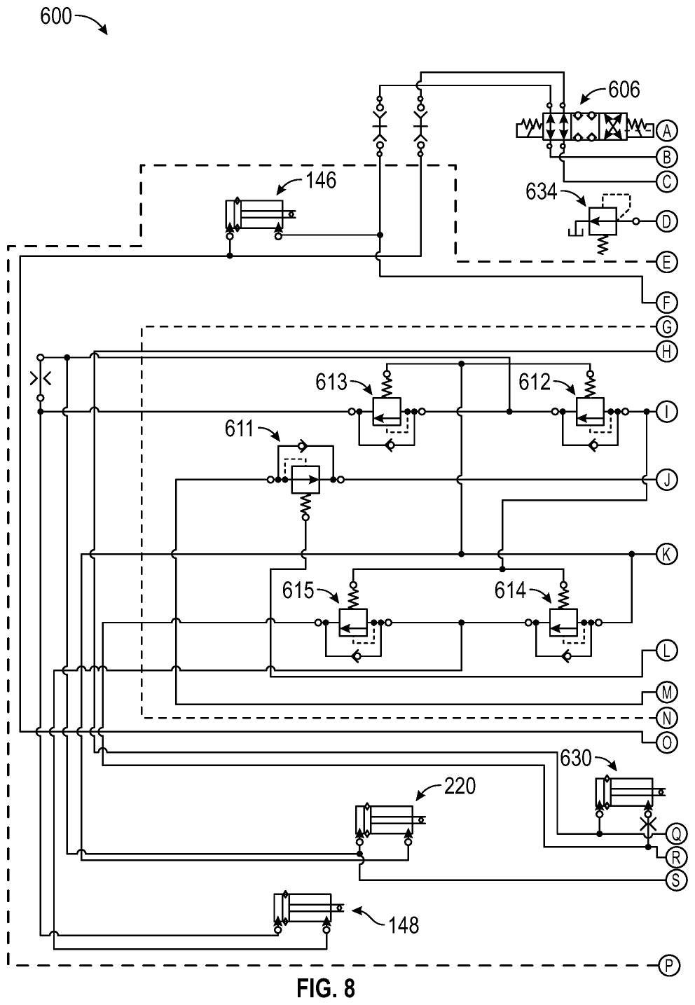

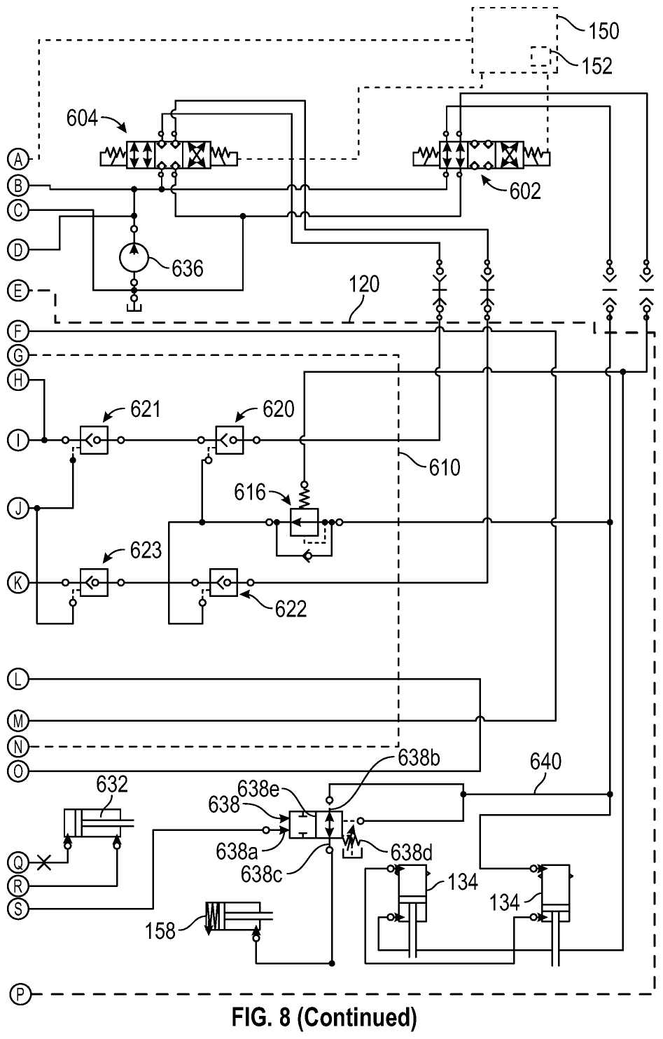

FIG. 8 shows the beginning of the operation to transition the moving device 120 from the field position to the transport position. To start, the controller 150 shifts the lift valve 602 so that a first hydraulic pressure is delivered to the lift actuators 134 and the tilt actuator 158. The first hydraulic pressure extends the lift actuators 134 to raise the trail frame 124 from the ground G, and contracts the tilt actuator 158 against the spring and/or gravity to raise the header 154. The extension of the actuators 134 will then trip the sequence valve 616 and open the associated check valves 620, 622. At or around the same time, the controller 150 shifts the swing valve 606 to apply hydraulic pressure to trip the associated sequence valve 611 and open check valves 621, 623.

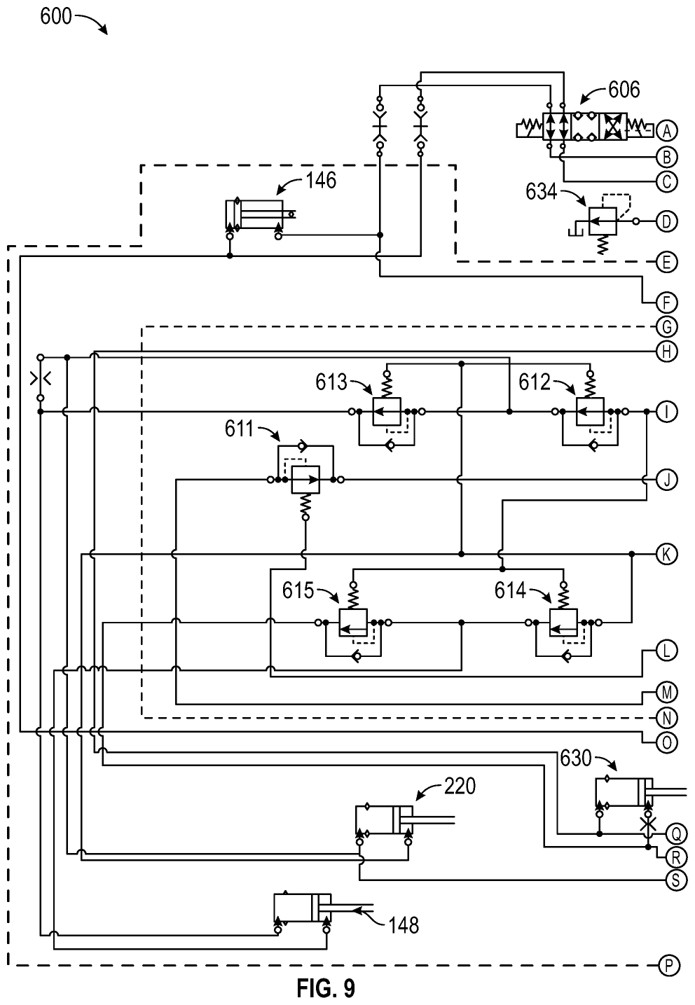

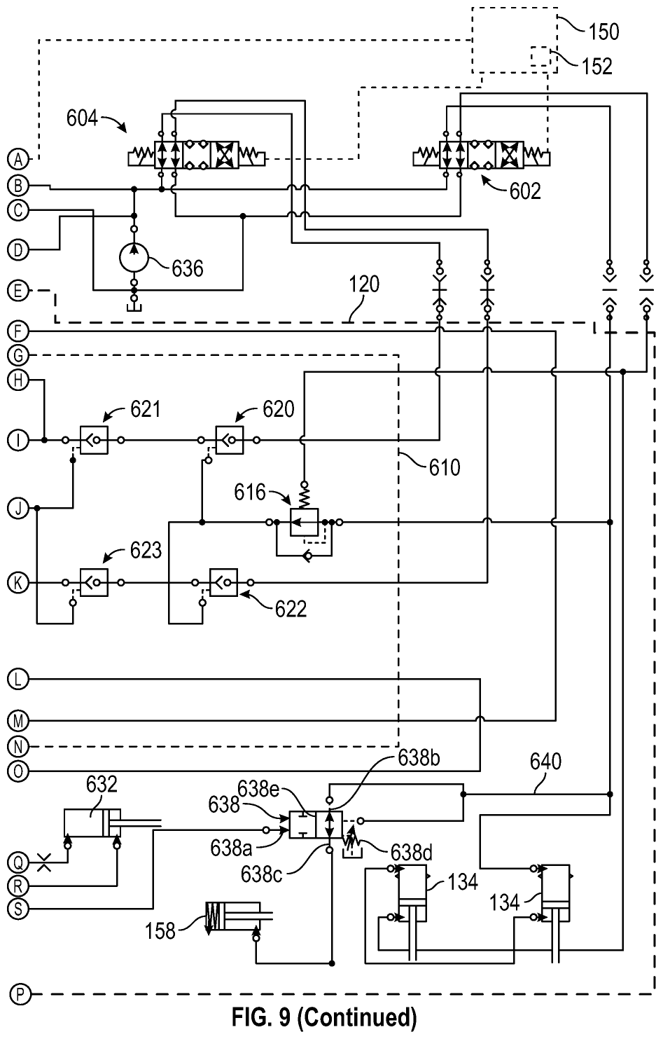

Moving to FIG. 9, the controller 150 operates the transport valve 604 to close sequence valves 614, 615, open sequence valves 612, 613, and convey pressurized fluid to operate the transport swing actuator 148, the transport actuator 220, the windrow shield actuator 630 (if provided), and the flail curtain actuator 632 (if provided). These actuators respectively operate to rotate the trail frame 124 relative to the tongue 122, lower the transport wheels 204, 206 to contact the ground G, fold the windrow shields 160 against the trail frame 124, and stow the flail curtain. The hydraulic circuit may be configured to sequence these operations in any desired manner (e.g., by throttling certain parts of the hydraulic circuit to delay operations, adding additional sequence valves, and so on). In this case, upon full extension of the transport swing actuator 148, the sequence valve 613 is tripped to channel more hydraulic fluid flow to the transport actuator 220 in order to speed up deployment of the transport frame 202.

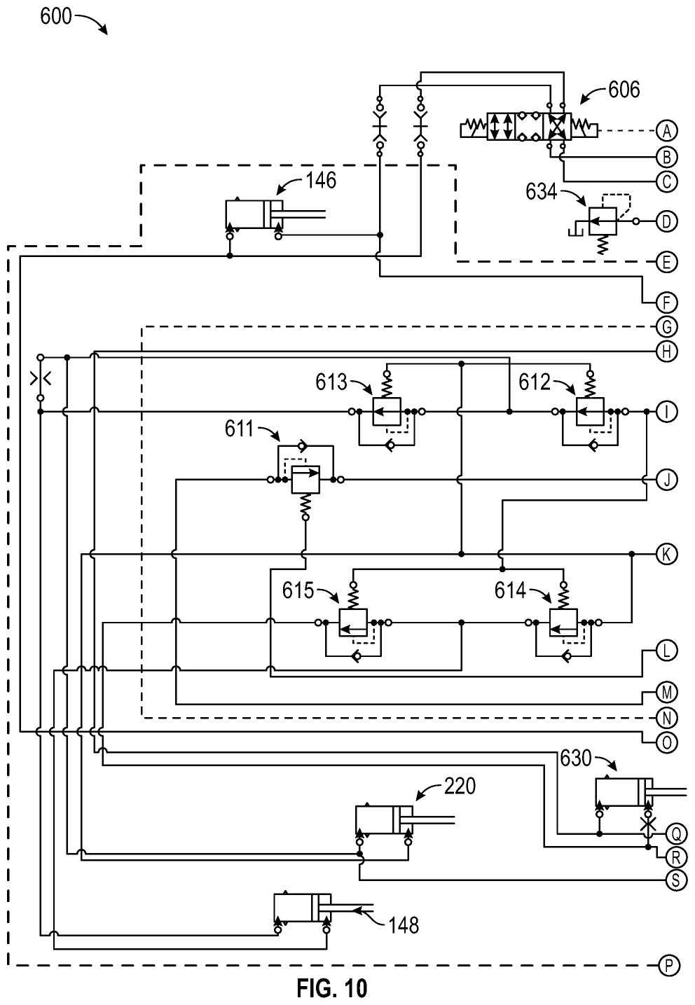

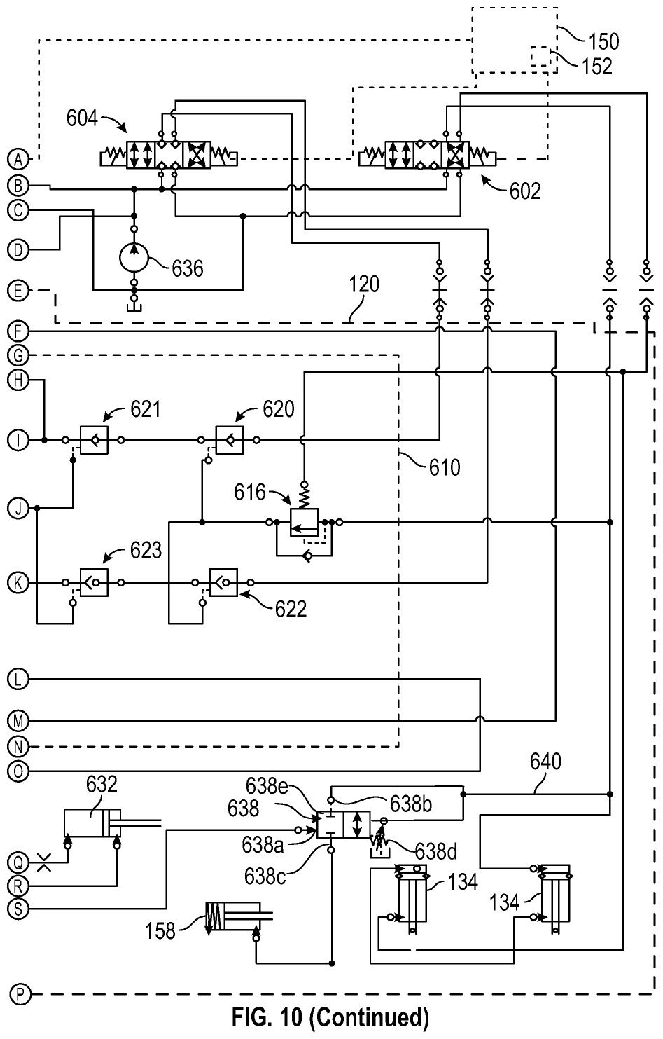

Moving to FIG. 10, the hydraulic pressure in the transport actuator 220 eventually increases to bias the pilot valve 638 against the return spring 638d, and move the shuttle body 638e to block flow between the flow inlet 638b and the flow outlet 638c. At this point, the hydraulic fluid is captured in the tilt actuator 158, locking the header 154 in the raised position.

As also shown in FIG. 10, the controller 150 shifts the transport valve 604 to the blocked position and shifts the swing valve 606 to fully extend the field swing actuator 146 in order to place the trail frame 124 in its full lateral transport position, wherein the trail frame 124 is substantially parallel to the towing tongue 122. The controller 150 then shifts the lift valve 602 to its lower position, and thereby operate the lift actuators 134 to raise the field wheels 126, 128 relative to the trail frame 124 and decrease clearance between the field wheels 126, 128 and the ground G.

During steady-state, i.e., constant, transport or road operation of the mowing device 120, the check valves 620, 621, 622, 623 will be closed, which disables transport hydraulic function during transport of the mowing device 120. Valve 638 also remains closed, to prevent the header 154 from lowering regardless of the state of the lift actuators 134.

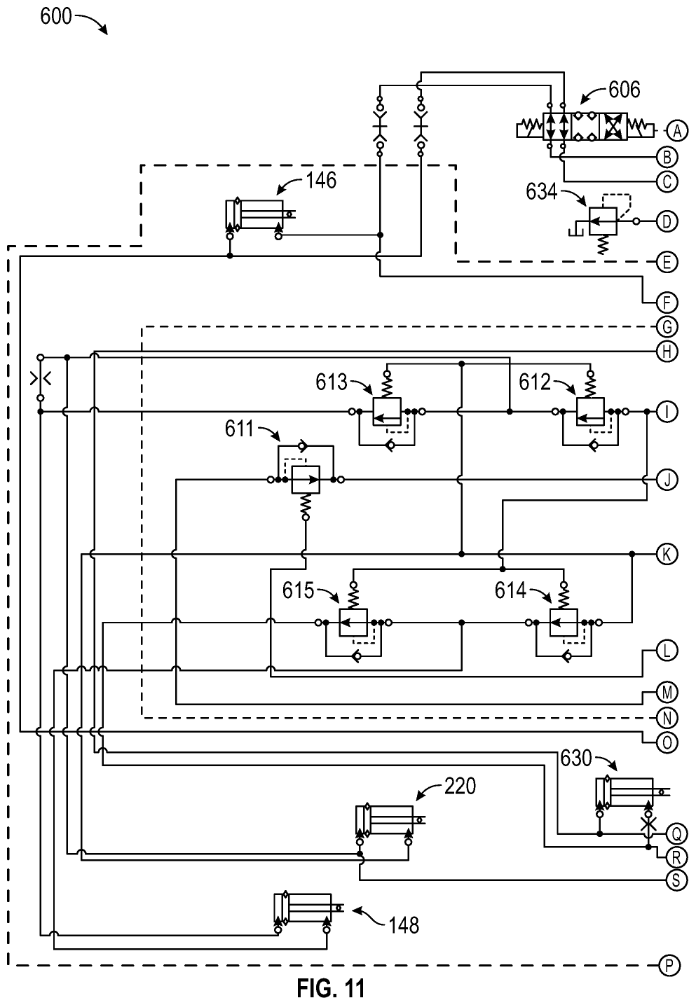

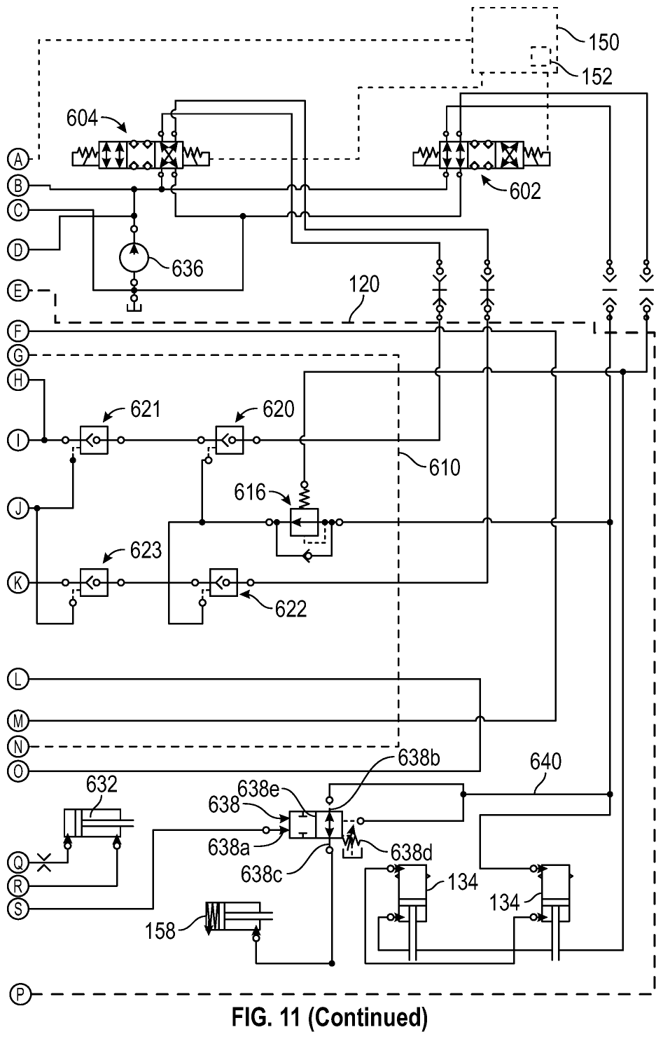

FIG. 11 shows a portion of the process to return to the field position from the transport position. First, the controller 150 shifts the lift valve 602 to extend the lift actuators 134, tripping the sequence valve 616 and opening the check valves 620, 622. The controller 150 also shifts the swing valve 606 to retract and pressurize the field swing actuator 146, tripping sequence valve 611 and opening check valves 621, 623. Thereafter, the controller 150 shifts the transport valve 604 to provide hydraulic fluid flow through check valves 622, 623. Then, the transport actuator 220 will retract. Once the transport actuator 220 has fully retracted, the sequence valve 614 trips, which allows hydraulic fluid flow to operate the transport swing actuator 148, and when the transport swing actuator 148 is fully retracted sequence valve 615 is tripped to convey pressurized fluid to retract the windrow shield actuator 630 (if provided), and flail curtain actuator 632 (if provided). FIG. 11 also shows that, upon termination of pressure on the input side of the transport actuator 220, the pilot valve spring 638d moves the shuttle body 638e to reconnect the pilot flow inlet 638b to the pilot flow outlet 638c. This reconnects tilt actuator 158 with the remainder of the hydraulic circuit 600, but, with the lift valve in the position shown in FIG. 11, pressurized fluid is delivered to the tilt actuator 158 to hold the header 154 in the raised position.

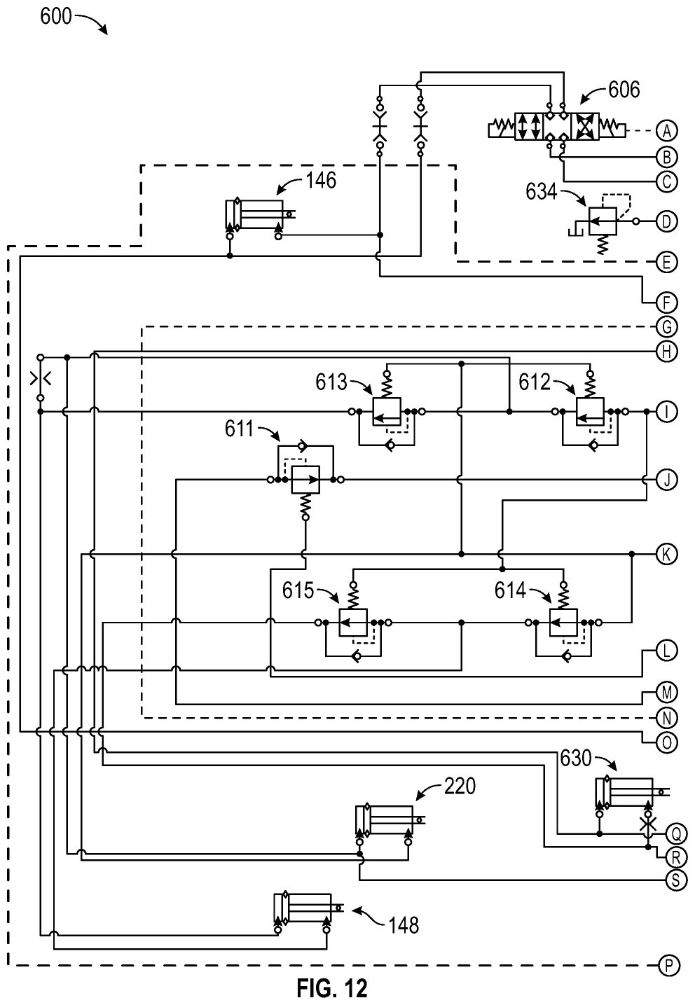

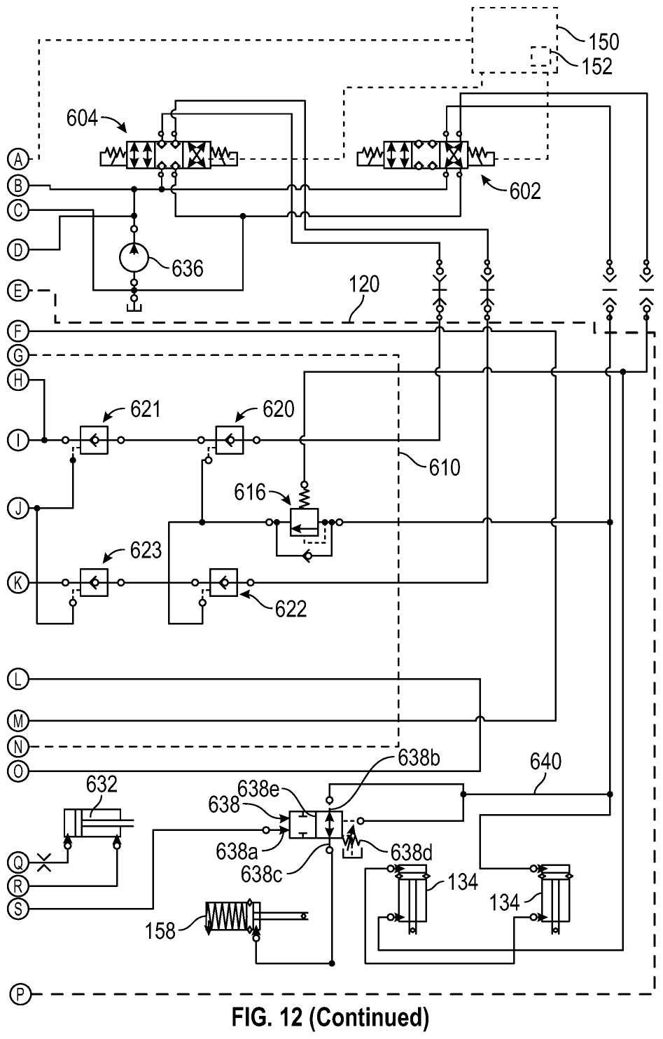

FIG. 12 shows a subsequent operation stage to return to the field position. Here, the controller moves the transport valve 604 and swing valve 606 to their respective locked position, and moves the lift valve 602 to reverse flow and retract the lift cylinders 134. At the same time, the lift valve 602 connects the tilt actuator 158 to drain, thus allowing the tilt actuator 158 to extend and return the header 154 to the lowered position. The mowing device 120 is now configured to resume field operation.

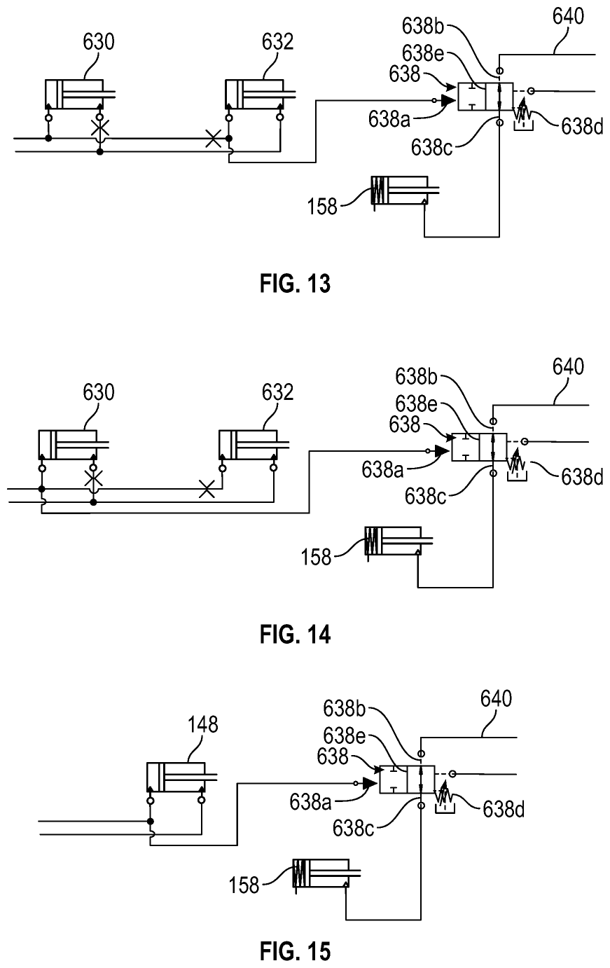

In the foregoing embodiment, the pilot input 638a is hydraulically connected to an input of the transport actuator 220, but it will be appreciated that it can instead be hydraulically connected to other actuators or other parts of the hydraulic circuit 600 that are pressurized while the mowing device 120 is being configured into the transport position. As some examples, FIG. 13 shows the pilot input 638a being hydraulically connected to an input of the flail curtain actuator 632, FIG. 14 shows the pilot input 638a being hydraulically connected to an input of the windrow shield actuator 630, and FIG. 15 shows the pilot input 638a being hydraulically connected to an input of the transport swing cylinder 148.

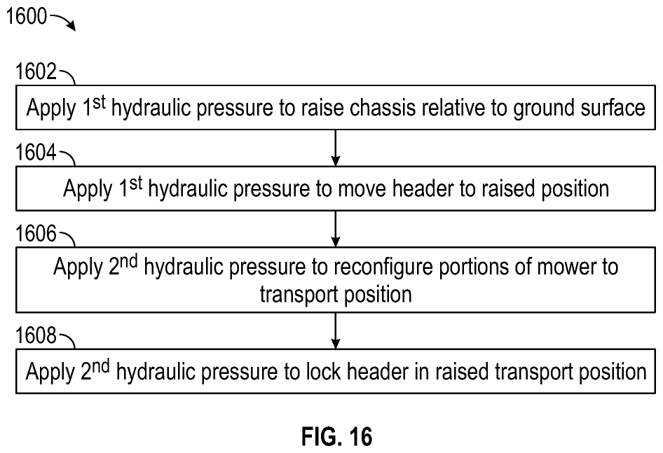

FIG. 16 depicts a flowchart of an exemplary method 1600 for operating an agricultural mowing device 120 having a chassis (e.g., a trail frame 124), field wheels 126, 128 configured to selectively support the chassis 124 on a surface G, a header 154, a tilt actuator 158 operatively connected between the header 154 and the chassis 124, a tongue 122 pivotally connected to the chassis 124 to rotate relative to the chassis 124 about a tongue pivot axis A1, and transport wheels 204, 206 configured to selectively support the chassis 124 on the surface G. The method 1600 generally includes: extending the field wheels 126, 128 relative to the chassis 124 to raise the chassis 124 relative to the surface G (block 1602); applying a first hydraulic pressure to the header 154 via a tilt actuator input path 640 to move the header 154 to a raised position relative to the chassis 124 (block 1604); applying a second hydraulic pressure to one or more actuators 148, 220, 630, 632 to reposition portions of the agricultural machine 120 to the transport position (block 1606); and applying the second hydraulic pressure to a valve 638 in the tilt actuator input path 640 to close the valve 638 and lock the header 154 in the raised position (block 1608). The steps can be performed in the manners explained previously herein. For example, steps 1606 and 1608 may be performed essentially simultaneously (e.g., at the same time or in an ordered sequency by operation of sequencing valves). Additionally, the steps may be performed in any sequence, simultaneously, or intermittently, to achieve the goal of placing the mowing device 120 into the transport position.

The method also may include steps such as: retracting the field wheels 126, 128 relative to the chassis 124 after closing the valve 638; moving the transport wheels 204, 206 to support the chassis 124 on the surface after closing the valve 638; transporting the agricultural machine 120 on the surface G after moving the transport wheels 204, 206 to support the chassis 124 on the surface G; and extending the field wheels 126, 128 and moving the transport wheels 204, 206 such that the field wheels 126, 128 support the chassis 124 on the surface, and opening the valve 638 to allow the header 154 to return to a lowered position relative to the chassis 124.

It will also be understood that the process of applying the second hydraulic reposition the agricultural machine 120 from a field position to a transport position can be performed in various ways, such as: applying the second hydraulic pressure to a windrow shield actuator 630 to move a windrow shield 160 into a folded position relative to the chassis 124; applying the second hydraulic pressure to a lateral transport actuator 220 to move the transport wheels 204, 206 to support the chassis 124 on the surface G and remove the field wheels 126, 128 from contact with the surface G; applying the second hydraulic pressure to hydraulic flail curtain actuator 632 to move a flail curtain to a stowed position relative to the chassis; and/or applying the second hydraulic pressure to a hydraulic transport swing actuator 148 to rotate the chassis 124 relative to the tongue 122.

Examples of the foregoing method steps are described above in relation to FIGS. 7-12.

These and other methods of operating a mowing device 120 may be performed manually, by a controller 150, or by a combination or manual and automated controls. Furthermore, it should be appreciated that the operator may stay within the cab of the agricultural vehicle 110 while the method 1600 is performed.

It is to be understood that the steps of the method 1600, and the other procedures described herein, may be performed by the controller 150 upon loading and executing software code or instructions which are tangibly stored on a non-transitory computer readable medium, such as on a magnetic medium, e.g., a computer hard drive, an optical medium, e.g., an optical disc, solid-state memory, e.g., flash memory, or other storage media known in the art. Thus, any of the functionality performed by the controller 150 described herein, such as the method 1600, is implemented in software code or instructions which are tangibly stored on a tangible computer readable medium. The controller 150 loads the software code or instructions via a direct interface with the computer readable medium or via a wired and/or wireless network. Upon loading and executing such software code or instructions by the controller 150, the controller 150 may perform any of the functionality of the controller 150 described herein, including any steps of the method 1600 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein but is intended to include all changes and modifications that are within the scope and spirit of the invention.

All numerical values and numerical ranges provided herein, including in the claims, are presented with the understanding that some variation may be present according to typical manufacturing tolerances, operation tolerances, and measurement tolerances, and are intended to have a broad meaning in harmony with the common and accepted usage by those of ordinary skill in the art to which the subject matter of this disclosure pertains. Accordingly, these values should be interpreted as indicating that insubstantial or inconsequential modifications or alterations of the subject matter described and claimed are considered to be within the scope of the disclosure as recited in the appended claims. These principles apply regardless of whether a value is identified as being approximate in one circumstance and specific in another circumstance (e.g., identified with the qualifier “substantially” or the like in one appearance, and identified without the qualifier “substantially” or the like in another circumstance).

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

Except as otherwise made clear by principles of differentiation or specific narrowing language, the terms “coupled,” “operatively coupled,” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic or a combination thereof.

The operation and advantages, as well as other options and variations, of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein but is intended to include all changes and modifications that are within the scope and spirit of the invention.

What is claimed is:

1. An agricultural machine comprising:
a chassis;
field wheels configured to selectively support the chassis to move on a ground surface;
a header operatively coupled to the chassis and movable between a lowered position relative to the chassis and a raised position relative to the chassis, the header comprising harvesting elements;
a tilt actuator operatively connected between the header and the chassis and comprising a tilt actuator input path configured to receive a respective pressurized hydraulic fluid to operate the tilt actuator to move the header from the lowered position to the raised position; and
a hydraulic circuit configured to reconfigure the agricultural machine between a field position and a transport position, wherein the hydraulic circuit comprises:
a pilot valve located in the tilt actuator input path and movable between an open position in which the pilot valve does not block the tilt actuator input path and a closed position in which the pilot valve blocks the tilt actuator input path, and
a first hydraulic actuator having a first actuator input configured to receive a respective pressurized hydraulic fluid to operate the first hydraulic actuator during reconfiguration of the agricultural machine from the field position to the transport position,
wherein the pilot valve is operatively connected to the first actuator input and configured to move to the closed position when a respective pressurized hydraulic fluid is received at the pilot valve from the first actuator input, and move to the open position when the respective hydraulic fluid is not received at the pilot valve.

2. The agricultural machine of claim 1, wherein the tilt actuator comprises a single-acting actuator.

3. The agricultural machine of claim 2, wherein the tilt actuator comprises a return spring configured to bias the tilt actuator to move the header from the raised position to the lowered position.

4. The agricultural machine of claim 1, further comprising at least one windrow shield operatively coupled to the chassis and movable between an open position and a folded position, and wherein the first hydraulic actuator comprises a windrow shield actuator configured to move the windrow shield to the folded position upon receiving the respective pressurized hydraulic fluid at the first actuator input.

5. The agricultural machine of claim 1, further comprising a lateral transport assembly comprising transport wheels, wherein the lateral transport assembly is operatively coupled to the chassis and moveable between a stowed position in which the transport wheels are not contacting the ground and a transport position in which the transport wheels are contacting the ground to support the chassis to move on the ground surface, and wherein the first hydraulic actuator comprises a lateral transport actuator configured to move the lateral transport assembly from the stowed position to the transport position upon receiving the respective pressurized hydraulic fluid at the first actuator input.

6. The agricultural machine of claim 1, further comprising a flail curtain operatively coupled to the chassis and movable between an operating position and a stowed position, and wherein the first hydraulic actuator comprises a flail curtain actuator configured to move the flail curtain to the stowed position upon receiving the respective pressurized hydraulic fluid at the first actuator input.

7. The agricultural machine of claim 1, wherein the first hydraulic actuator comprises a transport swing actuator operatively coupled between the chassis and a tongue pivotally connected to the chassis, wherein the transport swing actuator is configured to move the chassis relative to the tongue about the tongue pivot axis to a stowed position upon receiving the respective pressurized hydraulic fluid at the first actuator input.

8. An agricultural machine comprising:
a chassis;
field wheels operatively coupled to the chassis and movable between a respective extended position relative to the chassis to support the chassis to move on a ground surface and a respective retracted position relative to the chassis;
a lift actuator operatively connected between the field wheels and the chassis and configured to move the field wheels from the retracted position to the extended position;
a header operatively coupled to the chassis and movable between a respective lowered position relative to the chassis and a respective raised position relative to the chassis, the header comprising harvesting elements;
a tilt actuator operatively connected between the header and the chassis and configured to move the header at least from the lowered position to the raised position; and
a hydraulic system configured to reconfigure the agricultural machine between a field position and a transport position, wherein the hydraulic system comprises:
a first hydraulic circuit configured to selectively apply a first hydraulic pressure to the lift actuator to move the field wheels to the extended position and to the tilt actuator to move the header to the raised position,
a valve configured to move to a closed position to hydraulically disconnect the tilt actuator from the lift actuator and maintain the first hydraulic pressure in the tilt actuator after terminating application of the first hydraulic pressure to the lift actuator, and
a second hydraulic circuit configured to selectively apply a second hydraulic pressure to move the valve to the closed position.

9. The agricultural machine of claim 8, further comprising:
a lateral transport assembly comprising transport wheels, wherein the lateral transport assembly is operatively coupled to the chassis and moveable between a stowed position in which the transport wheels are not contacting the ground and a transport position in which the transport wheels are contacting the ground to support the chassis to move on the ground surface; and
a lateral transport actuator operatively connected between the lateral transport assembly and the chassis and configured to move the lateral transport assembly between the stowed position and the transport position;
wherein the second hydraulic circuit is connected between an input to the lateral transport actuator and the valve.

10. The agricultural machine of claim 8, further comprising:
a tongue extending in a longitudinal direction from a proximal tongue end to a distal tongue end, wherein the distal tongue end is pivotally connected to the chassis to rotate relative to the chassis about a tongue pivot axis; and
a transport swing actuator operatively coupled between the chassis and the tongue and configured to move the chassis relative to the tongue about the tongue pivot axis;
wherein the second hydraulic circuit is connected between an input to the transport swing actuator and the valve.

11. The agricultural machine of claim 8, further comprising:
at least one windrow shield operatively coupled to the chassis and movable between an open position and a folded position; and
a windrow shield actuator configured to move the windrow shield to the folded position;
wherein the second hydraulic circuit is connected between an input to the windrow shield actuator and the valve.

12. The agricultural machine of claim 8, further comprising:
a flail curtain operatively coupled to the chassis and movable between an operating position and a stowed position; and
a flail curtain actuator configured to move the flail curtain to the stowed position;
wherein the second hydraulic circuit is connected between an input to the flail curtain actuator and the valve.

13. The agricultural machine of claim 8, wherein the valve comprises a pilot valve.

14. A method for operating an agricultural machine comprising a chassis, field wheels configured to selectively support the chassis on a surface, a header, and a tilt actuator operatively connected between the header and the chassis, the method comprising:
extending the field wheels relative to the chassis to raise the chassis relative to the surface;
applying a first hydraulic pressure to the header via a tilt actuator input path to move the header to a raised position relative to the chassis;
applying a second hydraulic pressure to one or more actuators to reposition the agricultural machine from a field position to a transport position; and
applying the second hydraulic pressure to a valve in the tilt actuator input path to close the valve and lock the header in the raised position.

15. The method of claim 14, wherein extending the field wheels comprises applying the first hydraulic pressure to extend the field wheels.

16. The method of claim 14, further comprising retracting the field wheels relative to the chassis after closing the valve.

17. The method of claim 14, wherein the agricultural machine further comprises transport wheels movably mounted to the chassis and configured to selectively support the chassis on the surface, and applying a second hydraulic pressure to one or more actuators to reposition the agricultural machine from a field position to a transport position comprises moving the transport wheels to support the chassis on the surface.

18. The method of claim 17, further comprising transporting the agricultural machine on the surface after moving the transport wheels to support the chassis on the surface and applying the second hydraulic pressure to close the valve.

19. The method of claim 17, further comprising extending the field wheels and moving the transport wheels such that the field wheels support the chassis on the surface, and opening the valve to allow the header to return to a lowered position relative to the chassis.

20. The method of claim 14, wherein applying the second hydraulic pressure to the one or more actuators to reposition the agricultural machine from a field position to a transport position comprises one or more of:
applying the second hydraulic pressure to a windrow shield actuator to move a windrow shield into a folded position relative to the chassis;
applying the second hydraulic pressure to a lateral transport actuator to move transport wheels to support the chassis on the surface and remove the field wheels from contact with the surface;
applying the second hydraulic pressure to a hydraulic flail curtain actuator to move a flail curtain to a stowed position relative to the chassis; and
applying the second hydraulic pressure to a hydraulic transport swing actuator to rotate the chassis relative to a tongue pivotally connected to the chassis.
